(19) United States
(12) Patent Application Publication
(10) Pub. No.: US 2005/0093289 A1
(43) Pub. Date: May 5, 2005

(54) Book cover

(75) Inventor: Raymond Kam, New Territories (HK)

Correspondence Address: ALIX YALE & RISTAS LLP, 750 MAIN STREET, SUITE 1400, HARTFORD, CT, 06103, US

(73) Assignee: Rackel Industries Ltd.

(21) Appl. No.: 10/702,025

(22) Filed: Nov. 5, 2003

(51) Int. Cl. B42D 3/00

(52) U.S. Cl. 281/29

(57) ABSTRACT

A book cover includes an outer casing comprising a back portion and a front portion, and a sleeve attached to the back portion for receiving the back cover of a book such that a page of the book rests upon the sleeve. The book cover further includes a flap extending from the sleeve and having a pocket into which the front cover of the book can be received.

### BACKGROUND OF THE INVENTION

The present invention relates to book covers. More particularly, although not exclusively, the invention relates to a replaceable book cover in which a book such as a paperback novel or roadmap can be carried for reading or reference.

It is of course known to provide fixed book coverings. Books having such coverings are generally known as paperback or hardcover. Hardcover books are generally more expensive than the equivalent paperback and are more durable. People who do a lot of reading often purchase paperbacks as they are more readily available in the stores and are inexpensive. As the covers of such paperbacks lack durability, it would be advantageous to provide a removable cover in a standard size that can he transferred from as book-to-book desired.

### OBJECTS OF THE INVENTION

It is the object of the present invention to provide a cover that can be transferred from book-to-book as desired.

### DISCLOSURE OF THE INVENTION

There is disclosed herein a book cover comprising:
an outer casing comprising a back portion and a first front portion that is smaller than the back portion and a second front portion closable to the first front portion, and
a sleeve attached to the back portion for receiving the back cover of a book such that a page of the book rests upon the sleeve.

Preferably the second front portion substantially makes up the difference in size between the first front portion and the back portion.

Preferably the book cover for the comprises a flap extending from the sleeve and comprising a pocket into which the front cover of the book can be received.

Preferably the front portions are attached to one another by a fastener.

Preferably the fastener is a zipper.

Preferably the front portions are equally sized. Preferably the outer casing to less flexible than the sleeve.

### BRIEF DESCRIPTION OF THE DRAWINGS

A preferred form of the present invention will now be described by way of example with reference to the accompanying drawings, wherein:

FIG. 1 is a schematic perspective illustration of a closed book cover encasing a book,

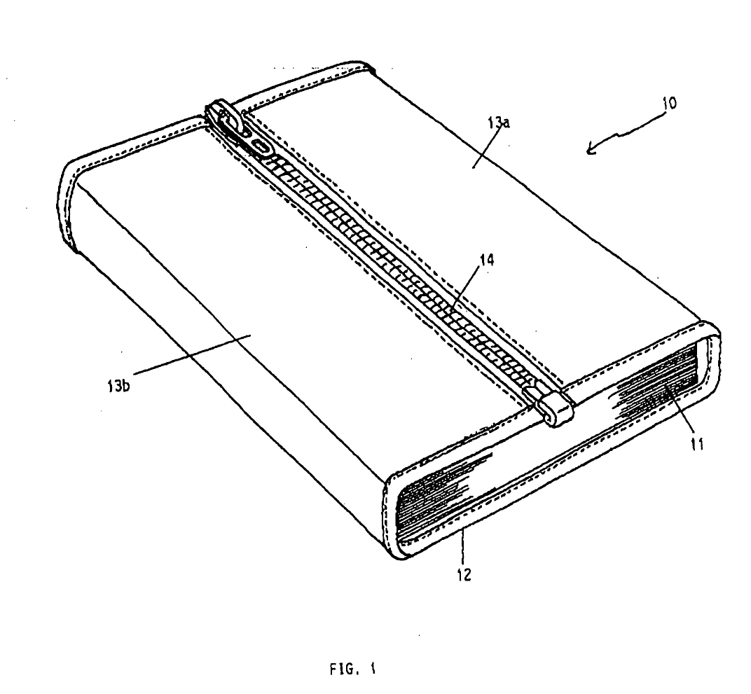

FIG. 2 is a schematic perspective illustration of the book cover and book of FIG. 1 in an open configuration, and

FIG. 3 is a schematic perspective illustration of the book cover of FIGS. 1 and 2 without the book.

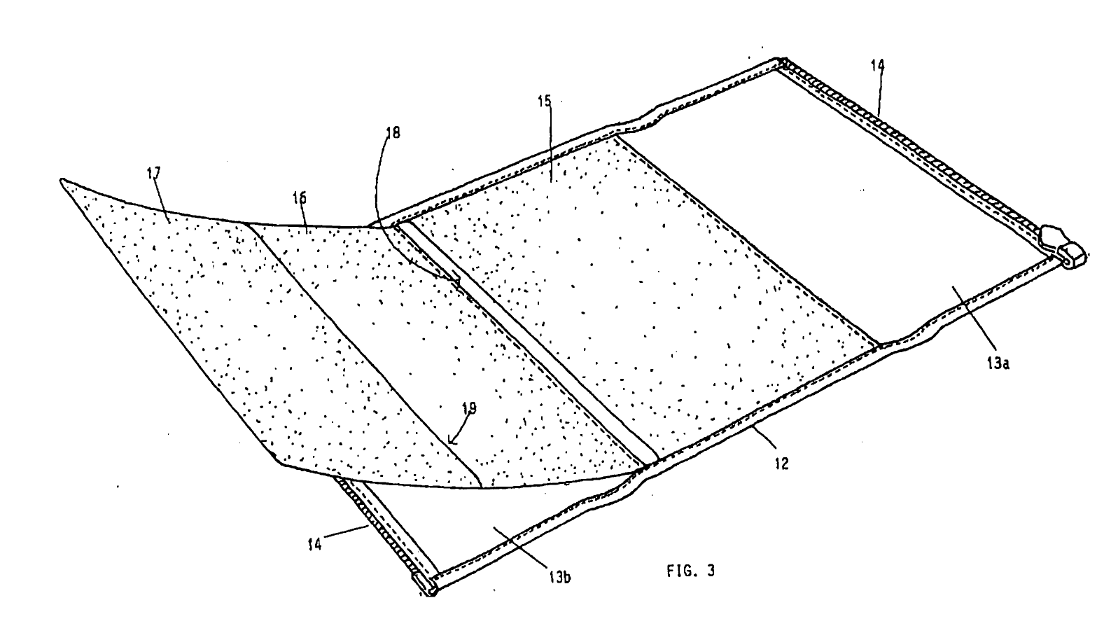

### DESCRIPTION OF THE PREFERRED EMBODIMENT

In the accompanying drawings there is depicted schematically a book cover 10 covering a paperback book 11. The book cover 10 comprises a casing having a back portion 12 and a pair of front portions 13a and 13b. The front and back portions are typically formed from elastic materials, however, leather, vinyl, paper, fabric or other protective, yet flexible material are envisaged.

A zipper 14 to close the casing connects the front portions 13a and 13b. There is a hem stitched about the casing periphery as shown.

Attached to the inside face of the back portion 12 is a sleeve 15 having an opening 18 into which the back cover of the book 11 can slide. The sleeve 15 would typically be formed of elastic material, however, plastics material, leather, vinyl, fabric, paper or other protective material would be suitable to allow the back cover of the book to be easily placed therebehind through the opening 18 and to allow for variation in the size of the book cover. A flap 16 is stitched, welded or glued to the casing and would typically be made of the same material as that from which the sleeve 15 is made. The flap includes a pocket 17 having an opening 19 into which the front cover of the book 11 can slide.

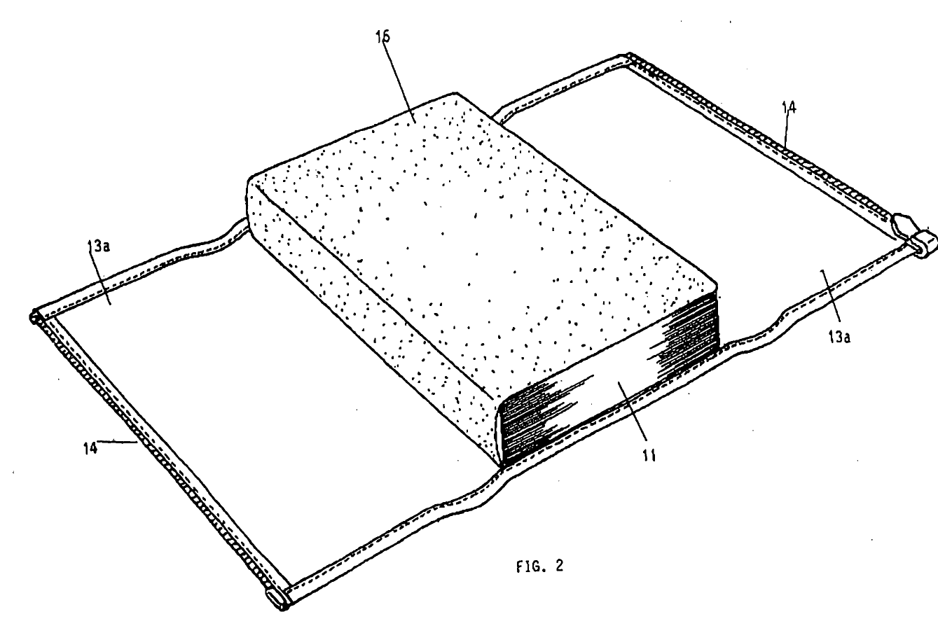

FIG. 2 shows the book 11 having both its front and rear covers received by the pocket 17 and sleeve 15 respectively.

The book 11 can be read while it is in the cover and thereafter the cover portions 13a and 13b can be zipped closed for safe-keeping and protection of the book. It should be appreciated that modifications and alterations obvious to those skilled into the art are not to be considered as beyond the scope of the present invention. For example, the front portions of the book cover need not necessarily be equally sized. That is, in one extreme, the zipper 14 might be provided alongside th spine of the book 11 or might even be replace d with other types of fasteners such as press-atuds in an overlapping edge configuration of the front portions for example. In any event, the book cover is intended to be used on all types of books including soft covers, notebooks, diaries, bibles and the like. Also, at least one of the front cover portions might have an edge and angle rather than vertical as shown. For example, where a zipper is provided, it might be at and angle to the vertical.

1. A book cover comprising:
an outer casing comprising a back portion and a first front portion that is smaller than the back portion and a second front portion closable to the first front portion, and
a sleeve attached to the back portion for receiving the back cover of a book such that a page of the book rests upon the sleeve.

2. The book cover of claim 1 wherein the second front portion substantially makes up the difference in size between the first front portion and the back portion.

3. The book cover of claim 1, further comprising a flap extending from the sleeve and comprising a pocket into which the front cover of the book can be received.

4. The book cover of claim 1 wherein the front portions are attached to one another by a fastener.

5. The book cover of claim 4 wherein the fastener is a zipper.

6. The book cover of claim 2 wherein the front portions are equally sized.

7. The book cover of claim 1 wherein the outer casing is less flexible than the sleeve.

8. The book cover of claim 3 wherein the outer casing is less flexible than the flap and pocket.
